(19) United States
(12) Patent Application Publication
(10) Pub. No.: US 2026/0135918 A1
(43) Pub. Date: May 14, 2026

(54) SYSTEMS AND METHODS FOR ESTABLISHING RENDEZVOUS CONNECTION IN A CLOUD SERVICE WITH MULTI-CORE NODES

(71) Applicant: Citrix Systems, Inc., Fort Lauderdale, FL (US)

(72) Inventor: Viswanath Yarangatta Suresh, Bangalore (IN)

(73) Assignee: Citrix Systems, Inc., Fort Lauderdale, FL (US)

(21) Appl. No.: 18/944,933

(22) Filed: Nov. 12, 2024

(51) Int. Cl. H04L 67/141; H04L 67/63

(52) U.S. Cl. CPC H04L 67/141; H04L 67/63

(57) ABSTRACT

Systems and methods for establishing rendezvous connections in cloud services environment including one or more multi-core nodes may include a controller which receives first information from a first device, where the first information relates to a request to establish a connection from a client to the server. The first information may include connection information corresponding to the request and configuration data of the first device. The controller may transmit a token generated by the controller according to the first information from the first device, to a connector of the server. The controller may receive second information from a second device. The second information may relate to establishing a rendezvous connection, and include the token received by the second device from the connector of the server. The controller may transmit, to the second device, third information, to cause the second device to establish the rendezvous connection with the first device.

### FIELD OF THE DISCLOSURE

The present application generally relates to managing connections in a cloud service. In particular, the present application relates to systems and methods for establishing a rendezvous connection in a cloud service with one or more nodes having multiple cores (e.g., multi-core nodes).

### BACKGROUND

In some networked systems, routing and management of connections between clients and servers may be implemented for improved performance and scalability. Some techniques may be used to optimize the handling of network traffic, including the use of flow redirectors and service nodes to manage connections and distribute workloads.

### BRIEF SUMMARY

This summary is provided to introduce a selection of concepts in a simplified form that are further described below in the Detailed Description. This summary is not intended to identify key features or essential features, nor is it intended to limit the scope of the claims included herewith.

In various cloud service deployments, various nodes (e.g., service nodes), flow redirectors, proxies, and/or other intermediary devices may be along a network path between a client (or client device) and a server (e.g., a server hosting a cloud service or other resource). To facilitate communication between a client device and the server hosting the cloud service/resource, an appropriate path may be established between the client and the server. Some deployments may support a rendezvous connection from, e.g., a flow redirector back to a service node. For example, when a client sends a request to establish a connection to the service node, the service node may not initiate a connection with the server directly. Rather, the service node may initiate the connection through various other intermediary devices, such as flow redirectors and/or other proxies.

Where a node (such as the service node or any other intermediary device) has multiple cores that handle traffic, incoming and rendezvous connections may land on different cores, which can result in steering of packets internally (e.g., at the node), which can impact overall performance and introduce latency. For example, assuming a multicore service node receives a request to establish a connection from a client device on a first core, the service node may forward that request via various intermediary devices to the server. The server may respond to the request via various intermediary devices, to establish the rendezvous connection back with the service node. Where the rendezvous connection is received on a different core of the service node (e.g., other than the first core), the service node may steer the packet from the different core to the first core, such that both connections are maintained by the same core. Similar examples may be applied at other intermediary devices, such as the flow redirectors or proxies, where such devices have multiple cores that handle network traffic.

According to the systems and methods described herein, a controller may be deployed or otherwise provided in the cloud computing environment. The controller may receive information from a first device (e.g., a service node) and relating to a request to establish a connection from a client to a server received by the first device. The information may include connection information corresponding to the request and configuration data of the first device (e.g., connection information, a hash obtained from parameters within the received packet, such as a hash—e.g., an RSS hash using an RSS hash key—involving a combination of 2 or 4 tuple of source IP, Destination IP, Source Port and Destination Port, also sometimes extension headers in case of IPv6, core information, such as number of cores, core identifiers, central processing unit (CPU) identifiers, weightage associated with each core, and so forth). The controller may transmit a token generated according to the information received from the first device, to the server. The server may transmit the token back to a second device (e.g., a flow redirector or other proxy/intermediary device), to establish the rendezvous connection from the flow redirector to the service node. To establish the rendezvous connection, the flow redirector may transmit information (e.g., including the token) to the controller. The controller may transmit a response to the second device including information to establish the rendezvous connection with the first device. For example, the controller may transmit, e.g., in the response, source and destination IP addresses and ports for the rendezvous connection, or may transmit the configuration information of the first device to the second device, for the second device to determine the source and destination IP addresses and ports for the rendezvous connection using the configuration information (e.g., of the first device and the second device).

The systems and methods described herein may be provided to eliminate packet steering within an intermediary device. For instance, the systems and methods described herein may prevent packet steering at a service node, such that a core which receives a request to establish a connection from a client device is the same core as the core which receives a rendezvous connection (e.g., from a flow redirector). As an example, by providing the information from the controller to the second device, such that the second device determines or identifies the core which receives the request, the second device can configure the packet such that the packet is handled by/addressed to/lands on the proper core of the first device, so that a different core does not receive the packet and have to steer the packet to the correct core. Similarly, the systems and methods described herein may prevent packet steering at a flow redirector (or other multi-core intermediary device or proxy). For instance, a multi-core flow redirector or other intermediary device may be configured such that the same core is used for communication between, e.g., the service node and intermediary device, and the intermediary device and the service node. For example, where the flow redirector receives the token from the server on a particular core, the flow redirector can provide configuration information of the flow redirector to the controller (along with the token), such that the information for establishing the rendezvous connection is received from the controller on the same core of the flow redirector, and that same core of the flow redirector is used for the rendezvous connection between the flow redirector and the service node.

In some aspects, this disclosure relates to a method. The method may include receiving, by a controller, from a first device intermediary to a client and a server, first information relating to a request to establish a connection from the client to the server received by the first device, the first information including connection information corresponding to the request and configuration data of the first device. The method may include transmitting, by the controller to a connector of the server, a token generated by the controller according to the first information from the first device. The method may include receiving, by the controller, from a second device intermediary to the client and the server, second information relating to establishing a rendezvous connection corresponding to the connection, the second information including the token received by the second device from the connector of the server. The method may include transmitting, by the controller, to the second device, third information, to cause the second device to establish the rendezvous connection with the first device.

In some embodiments, the first device includes a service node of one or more service nodes, the service node including a plurality of cores, and the configuration data identifies a core of the plurality of cores which received the request from the client. In some embodiments, the second device includes a flow redirector including a plurality of cores. In some embodiments, the controller receives the second information, responsive to the flow redirector receiving the token from the server at a core of the plurality of cores of the flow redirector, and the rendezvous connection is established between the core of the flow redirector which received the token from the server, and a core of the first device which received the request. In some embodiments, the configuration data includes a hash key for the first device, layout information of the first device, and an identifier of a core of the first device which received the request. In some embodiments, the configuration data includes first configuration data of the first device, the second information further includes second configuration data of the second device, and the third information includes a source address, a source port, a destination address and a destination port to be used for the rendezvous connection between the first device and the second device.

In some embodiments, the third information includes the configuration data of the first device, causing the second device to determine a source address, a source port, a destination address and a destination port to be used for the rendezvous connection between the first device and the second device based on the configuration data of the first device and configuration data of the second device. In some embodiments, the method includes generating, by the controller, the token corresponding to the first information received from the first device. In some embodiments, the first device includes a core of a service node, the second device includes a core of a flow redirector, and wherein the rendezvous connection is established between the core of the service node which received the request, and the core of the flow redirector which received the token.

In another aspect, this disclosure is directed to a system. The system may include one or more first devices. At least one of the one or more first devices may include a processor including a plurality of cores. A core of the plurality of cores may be configured to receive, from a client device, a request to establish a connection between the client and a server. The core may be configured to transmit, to a controller, first information relating to the request, the first information including connection information corresponding to the request and configuration data of the first device, the controller transmitting a token corresponding to the first information to a connector of the server. The core may be configured to establish, responsive to receiving a signal from a second device, a rendezvous connection between the core of the first device and the second device, the second device transmitting the signal to the first device according to second information received from the controller, the second information determined by the controller based on the token received by the second device from the connector of the server.

In some embodiments, the one or more first devices include one or more service nodes, and the second device includes a flow redirector.

In yet another aspect, this disclosure is directed to a controller including one or more processors configured to receive, from a first device intermediary to a client and a server, first information relating to a request to establish a connection from the client to the server received by the first device, the first information including connection information corresponding to the request and configuration data of the first device; transmit, to a connector of the server, a token generated by the controller according to the first information from the first device. The one or more processors may be configured to receive, from a second device intermediary to the client and the server, second information relating to establishing a rendezvous connection corresponding to the connection, the second information including the token received by the second device from the connector of the server. The one or more processors may be configured to transmit, to the second device, third information, to cause the second device to establish the rendezvous connection with the first device.

In some embodiments, the first device includes a service node of one or more service nodes, the service node including a plurality of cores, and the configuration data identifies a core of the plurality of cores which received the request from the client. In some embodiments, the second device includes a flow redirector including a plurality of cores. In some embodiments, the one or more processors receive the second information, responsive to the flow redirector receiving the token from the server at a core of the plurality of cores of the flow redirector, and the rendezvous connection is established between the core of the flow redirector which received the token from the server, and a core of the first device which received the request. In some embodiments, the configuration data includes a hash key for the first device, layout information of the first device, and an identifier of a core of the first device which received the request. In some embodiments, the configuration data includes first configuration data of the first device, the second information further includes second configuration data of the second device, and the third information includes a source address, a source port, a destination address and a destination port to be used for the rendezvous connection between the first device and the second device.

In some embodiments, the third information includes the configuration data of the first device, causing the second device to determine a source address, a source port, a destination address and a destination port to be used for the rendezvous connection between the first device and the second device based on the configuration data of the first device and configuration data of the second device. In some embodiments, the one or more processors are further configured to generate the token corresponding to the first information received from the first device. In some embodiments, the first device includes a core of a service node, the second device includes a core of a flow redirector, and wherein the rendezvous connection is established between the core of the service node which received the request, and the core of the flow redirector which received the token.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles, and concepts. The drawings are not intended to limit the scope of the claims included herewith.

FIG. 1A is a block diagram of a network computing system, in accordance with an illustrative embodiment;

FIG. 1B is a block diagram of a network computing system for delivering a computing environment from a server to a client via an appliance, in accordance with an illustrative embodiment;

FIG. 1C is a block diagram of a computing device, in accordance with an illustrative embodiment;

FIG. 2 is a block diagram of an appliance for processing communications between a client and a server, in accordance with an illustrative embodiment;

FIG. 3 is a block diagram of a virtualization environment, in accordance with an illustrative embodiment;

FIG. 4 is a block diagram of a cluster system, in accordance with an illustrative embodiment;

FIG. 5 is a block diagram of a system for establishing rendezvous connections in a cloud service environment, in accordance with an illustrative embodiment;

FIG. 6 is a system flow of establishing rendezvous connections in a cloud service environment, in accordance with an illustrative embodiment;

FIG. 7 is another system flow of establishing rendezvous connections in a cloud service environment, in accordance with another illustrative embodiment;

FIG. 8 is a process flow for establishing rendezvous connections corresponding to a connection in a cloud service environment, in accordance with an illustrative embodiment;

FIG. 9 is a flowchart showing an example method of establishing rendezvous connections in cloud service environments, in accordance with an illustrative embodiment;

FIG. 10 is a flowchart showing an example method of establishing rendezvous connections in cloud service environments, in accordance with an illustrative embodiment; and

FIG. 11 is a flowchart showing an example method of establishing rendezvous connections in cloud service environments, in accordance with an illustrative embodiment.

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:
Section A describes a network environment and computing environment which may be useful for practicing embodiments described herein;
Section B describes embodiments of systems and methods for delivering a computing environment to a remote user;
Section C describes embodiments of systems and methods for virtualizing an application delivery controller;
Section D describes embodiments of systems and methods for providing a clustered appliance architecture environment;
Section E describes systems and methods for establishing rendezvous connections in a cloud service.
Section F describes embodiments of systems and methods for establishing rendezvous connections in a cloud service.

### A. Network and Computing Environment

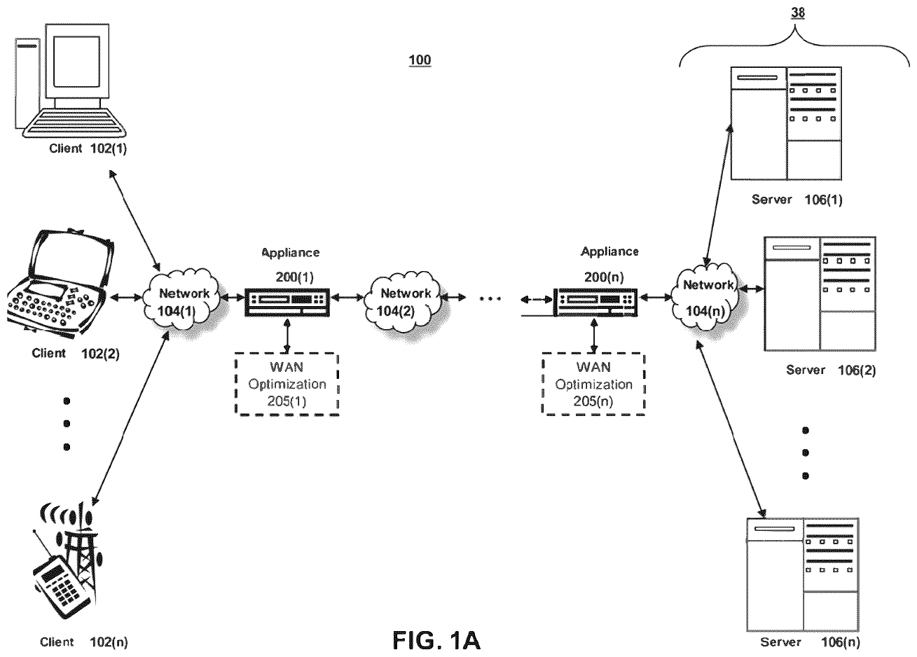

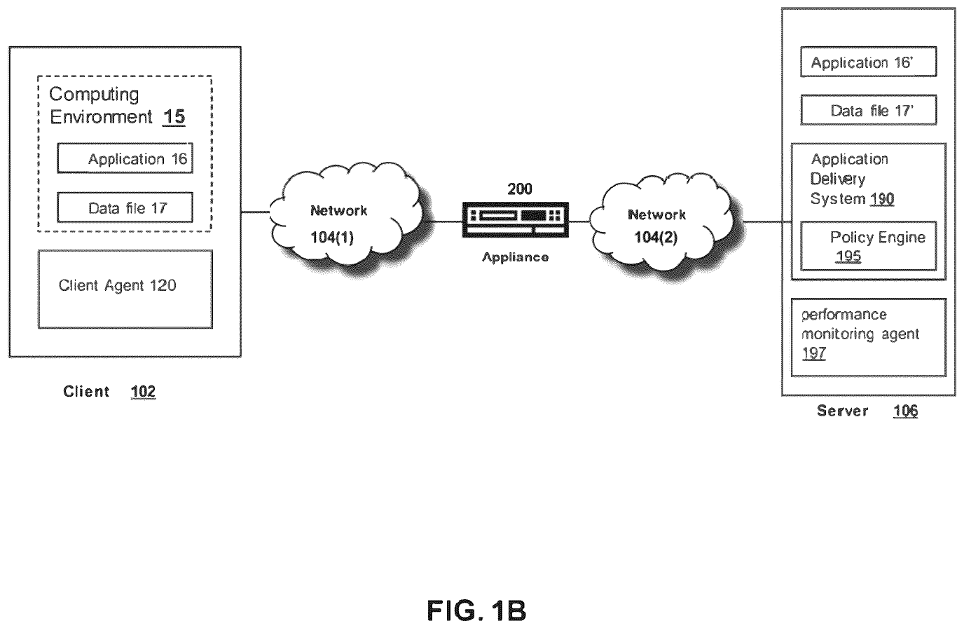

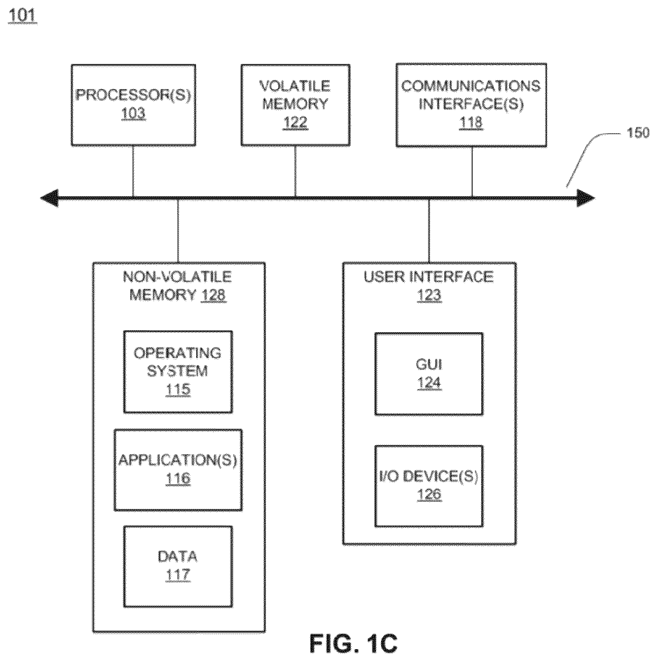

Referring to FIG. 1A, an illustrative network environment 100 is depicted. Network environment 100 may include one or more clients 102(1)-102(n) (also generally referred to as local machine(s) 102 or client(s) 102) in communication with one or more servers 106(1)-106(n) (also generally referred to as remote machine(s) 106 or server(s) 106) via one or more networks 104(1)-104n (generally referred to as network(s) 104). In some embodiments, a client 102 may communicate with a server 106 via one or more appliances 200(1)-200n (generally referred to as appliance(s) 200 or gateway(s) 200).

Although the embodiment shown in FIG. 1A shows one or more networks 104 between clients 102 and servers 106, in other embodiments, clients 102 and servers 106 may be on the same network 104. The various networks 104 may be the same type of network or different types of networks. For example, in some embodiments, network 104(1) may be a private network such as a local area network (LAN) or a company Intranet, while network 104(2) and/or network 104(n) may be a public network, such as a wide area network (WAN) or the Internet. In other embodiments, both network 104(1) and network 104(n) may be private networks. Networks 104 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

As shown in FIG. 1A, one or more appliances 200 may be located at various points or in various communication paths of network environment 100. For example, appliance 200 may be deployed between two networks 104(1) and 104(2), and appliances 200 may communicate with one another to work in conjunction to, for example, accelerate network traffic between clients 102 and servers 106. In other embodiments, the appliance 200 may be located on a network 104. For example, appliance 200 may be implemented as part of one of clients 102 and/or servers 106. In an embodiment, appliance 200 may be implemented as a network device (e.g., a network node) such as Citrix networking (formerly NetScaler®) products sold by Citrix Systems, Inc. of Fort Lauderdale, FL.

As shown in FIG. 1A, one or more servers 106 may operate as a server farm 38. Servers 106 of server farm 38 may be logically grouped, and may either be geographically co-located (e.g., on premises) or geographically dispersed (e.g., cloud based) from clients 102 and/or other servers 106. In an embodiment, server farm 38 executes one or more applications on behalf of one or more of clients 102 (e.g., as an application server), although other uses are possible, such as a file server, gateway server, proxy server, or other similar server uses. Clients 102 may seek access to hosted applications on servers 106.

As shown in FIG. 1A, in some embodiments, appliances 200 may include, be replaced by, or be in communication with, one or more additional appliances, such as WAN optimization appliances 205(1)-205(n), referred to generally as WAN optimization appliance(s) 205. For example, WAN optimization appliance 205 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, appliance 205 may be a performance enhancing proxy or a WAN optimization controller. In one embodiment, appliance 205 may be implemented as Citrix SD-WAN products sold by Citrix Systems, Inc. of Fort Lauderdale, FL.

Referring to FIG. 1B, an example network environment, 100′, for delivering and/or operating a computing network environment on a client 102 is shown. As shown in FIG. 1B, a server 106 may include an application delivery system 190 for delivering a computing environment, application, and/or data files to one or more clients 102. Client 102 may include client agent 120 and computing environment 15. Computing environment 15 may execute or operate an application, 16, that accesses, processes or uses a data file 17. Computing environment 15, application 16 and/or data file 17 may be delivered via appliance 200 and/or the server 106.

Appliance 200 may accelerate delivery of all or a portion of computing environment 15 to a client 102, for example by the application delivery system 190. For example, appliance 200 may accelerate delivery of a streaming application and data file processable by the application from a data center to a remote user location by accelerating transport layer traffic between a client 102 and a server 106. Such acceleration may be provided by one or more techniques, such as: 1) transport layer connection pooling, 2) transport layer connection multiplexing, 3) transport control protocol buffering, 4) compression, 5) caching, or other techniques. Appliance 200 may also provide load balancing of servers 106 to process requests from clients 102, act as a proxy or access server to provide access to the one or more servers 106, provide security and/or act as a firewall between a client 102 and a server 106, provide Domain Name Service (DNS) resolution, provide one or more virtual servers or virtual internet protocol servers, and/or provide a secure virtual private network (VPN) connection from a client 102 to a server 106, such as a secure socket layer (SSL) VPN connection and/or provide encryption and decryption operations.

Application delivery management system 190 may deliver computing environment 15 to a user (e.g., client 102), remote or otherwise, based on authentication and authorization policies applied by policy engine 195. A remote user may obtain a computing environment and access to server stored applications and data files from any network-connected device (e.g., client 102). For example, appliance 200 may request an application and data file from server 106. In response to the request, application delivery system 190 and/or server 106 may deliver the application and data file to client 102, for example via an application stream to operate in computing environment 15 on client 102, or via a remote-display protocol or otherwise via remote-based or server-based computing. In an embodiment, application delivery system 190 may be implemented as any portion of the Citrix Workspace Suite™ by Citrix Systems, Inc., such as Citrix Virtual Apps and Desktops (formerly XenApp® and XenDesktop®).

Policy engine 195 may control and manage the access to, and execution and delivery of, applications. For example, policy engine 195 may determine the one or more applications a user or client 102 may access and/or how the application should be delivered to the user or client 102, such as a server-based computing, streaming or delivering the application locally to the client 102 for local execution.

For example, in operation, a client 102 may request execution of an application (e.g., application 16′) and application delivery system 190 of server 106 determines how to execute application 16′, for example based upon credentials received from client 102 and a user policy applied by policy engine 195 associated with the credentials. For example, application delivery system 190 may enable client 102 to receive application-output data generated by execution of the application on a server 106, may enable client 102 to execute the application locally after receiving the application from server 106, or may stream the application via network 104 to client 102. For example, in some embodiments, the application may be a server-based or a remote-based application executed on server 106 on behalf of client 102. Server 106 may display output to client 102 using a thin-client or remote-display protocol, such as the Independent Computing Architecture (ICA) protocol by Citrix Systems, Inc. of Fort Lauderdale, FL. The application may be any application related to real-time data communications, such as applications for streaming graphics, streaming video and/or audio or other data, delivery of remote desktops or workspaces or hosted services or applications, for example infrastructure as a service (IaaS), desktop as a service (DaaS), workspace as a service (WaaS), software as a service (SaaS) or platform as a service (PaaS).

One or more of servers 106 may include a performance monitoring service or agent 197. In some embodiments, a dedicated one or more servers 106 may be employed to perform performance monitoring. Performance monitoring may be performed using data collection, aggregation, analysis, management and reporting, for example by software, hardware or a combination thereof. Performance monitoring may include one or more agents for performing monitoring, measurement and data collection activities on clients 102 (e.g., client agent 120), servers 106 (e.g., agent 197) or an appliance 200 and/or 205 (agent not shown). In general, monitoring agents (e.g., 120 and/or 197) execute transparently (e.g., in the background) to any application and/or user of the device. In some embodiments, monitoring agent 197 includes any of the product embodiments referred to as Citrix Analytics or Citrix Application Delivery Management by Citrix Systems, Inc. of Fort Lauderdale, FL.

The monitoring agents 120 and 197 may monitor, measure, collect, and/or analyze data on a predetermined frequency, based upon an occurrence of given event(s), or in real time during operation of network environment 100. The monitoring agents may monitor resource consumption and/or performance of hardware, software, and/or communications resources of clients 102, networks 104, appliances 200 and/or 205, and/or servers 106. For example, network connections such as a transport layer connection, network latency, bandwidth utilization, end-user response times, application usage and performance, session connections to an application, cache usage, memory usage, processor usage, storage usage, database transactions, client and/or server utilization, active users, duration of user activity, application crashes, errors, or hangs, the time required to log-in to an application, a server, or the application delivery system, and/or other performance conditions and metrics may be monitored.

The monitoring agents 120 and 197 may provide application performance management for application delivery system 190. For example, based upon one or more monitored performance conditions or metrics, application delivery system 190 may be dynamically adjusted, for example periodically or in real-time, to optimize application delivery by servers 106 to clients 102 based upon network environment performance and conditions.

In described embodiments, clients 102, servers 106, and appliances 200 and 205 may be deployed as and/or executed on any type and form of computing device, such as any desktop computer, laptop computer, or mobile device capable of communication over at least one network and performing the operations described herein. For example, clients 102, servers 106 and/or appliances 200 and 205 may each correspond to one computer, a plurality of computers, or a network of distributed computers such as computer 101 shown in FIG. 1C.

As shown in FIG. 1C, computer 101 may include one or more processors 103, volatile memory 122 (e.g., RAM), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, etc.). Non-volatile memory 128 stores operating system 115, one or more applications 116, and data 117 such that, for example, computer instructions of operating system 115 and/or applications 116 are executed by processor(s) 103 out of volatile memory 122. Data may be entered using an input device of GUI 124 or received from I/O device(s) 126. Various elements of computer 101 may communicate via communication bus 150. Computer 101 as shown in FIG. 1C is shown merely as an example, as clients 102, servers 106 and/or appliances 200 and 205 may be implemented by any computing or processing environment and with any type of machine or set of machines that may have suitable hardware and/or software capable of operating as described herein.

Processor(s) 103 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 118 may include one or more interfaces to enable computer 101 to access a computer network such as a LAN, a WAN, or the Internet through a variety of wired and/or wireless or cellular connections.

In described embodiments, a first computing device 101 may execute an application on behalf of a user of a client computing device (e.g., a client 102), may execute a virtual machine, which provides an execution session within which applications execute on behalf of a user or a client computing device (e.g., a client 102), such as a hosted desktop session, may execute a terminal services session to provide a hosted desktop environment, or may provide access to a computing environment including one or more of: one or more applications, one or more desktop applications, and one or more desktop sessions in which one or more applications may execute.

### B. Appliance Architecture

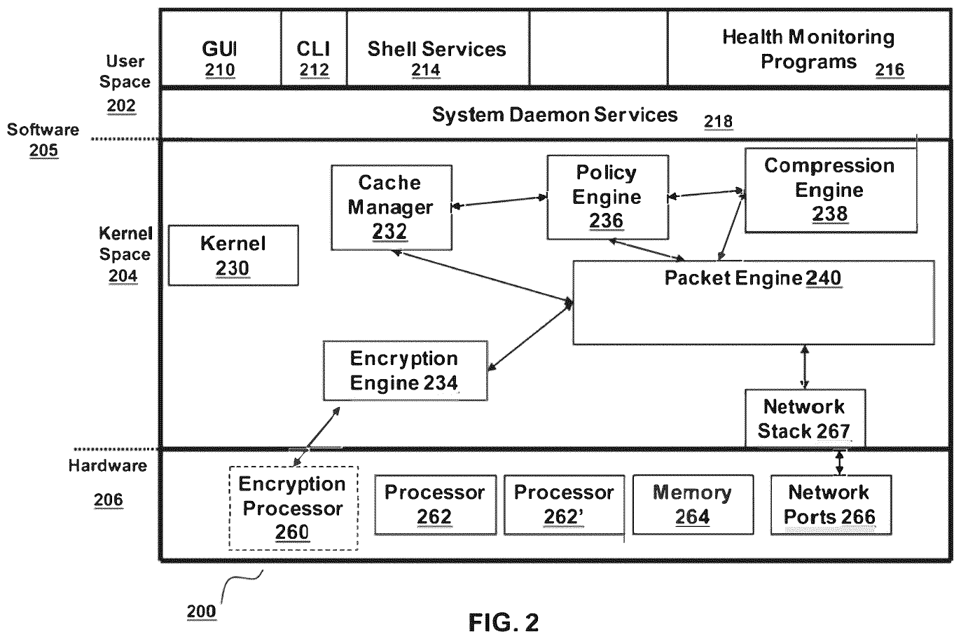

FIG. 2 shows an example embodiment of appliance 200. As described herein, appliance 200 may be implemented as a server, gateway, router, switch, bridge or other type of computing or network device. As shown in FIG. 2, an embodiment of appliance 200 may include a hardware layer 206 and a software layer divided into a user space 202 and a kernel space 204. Hardware layer 206 provides the hardware elements upon which programs and services within kernel space 204 and user space 202 are executed and allow programs and services within kernel space 204 and user space 202 to communicate data both internally and externally with respect to appliance 200. As shown in FIG. 2, hardware layer 206 may include one or more processing units 262 for executing software programs and services, memory 264 for storing software and data, network ports 266 for transmitting and receiving data over a network, and encryption processor 260 for encrypting and decrypting data such as in relation to Secure Socket Layer (SSL) or Transport Layer Security (TLS) processing of data transmitted and received over the network.

An operating system of appliance 200 allocates, manages, or otherwise segregates the available system memory into kernel space 204 and user space 202. Kernel space 204 is reserved for running kernel 230, including any device drivers, kernel extensions or other kernel related software. As known to those skilled in the art, kernel 230 is the core of the operating system, and provides access, control, and management of resources and hardware-related elements of appliance 200. Kernel space 204 may also include a number of network services or processes working in conjunction with cache manager 232.

Appliance 200 may include one or more network stacks 267, such as a TCP/IP based stack, for communicating with client(s) 102, server(s) 106, network(s) 104, and/or other appliances 200 or 205. For example, appliance 200 may establish and/or terminate one or more transport layer connections between clients 102 and servers 106. Each network stack 267 may include a buffer 243 for queuing one or more network packets for transmission by appliance 200.

Kernel space 204 may include cache manager 232, packet engine 240, encryption engine 234, policy engine 236 and compression engine 238. In other words, one or more of processes 232, 240, 234, 236 and 238 run in the core address space of the operating system of appliance 200, which may reduce the number of data transactions to and from the memory and/or context switches between kernel mode and user mode, for example since data obtained in kernel mode may not need to be passed or copied to a user process, thread or user level data structure.

Cache manager 232 may duplicate original data stored elsewhere or data previously computed, generated or transmitted to reducing the access time of the data. In some embodiments, the cache memory may be a data object in memory 264 of appliance 200, or may be a physical memory having a faster access time than memory 264.

Policy engine 236 may include a statistical engine or other configuration mechanism to allow a user to identify, specify, define or configure a caching policy and access, control and management of objects, data or content being cached by appliance 200, and define or configure security, network traffic, network access, compression or other functions performed by appliance 200.

Encryption engine 234 may process any security related protocol, such as SSL or TLS. For example, encryption engine 234 may encrypt and decrypt network packets, or any portion thereof, communicated via appliance 200, may setup or establish SSL, TLS or other secure connections, for example between client 102, server 106, and/or other appliances 200 or 205. In some embodiments, encryption engine 234 may use a tunneling protocol to provide a VPN between a client 102 and a server 106. In some embodiments, encryption engine 234 is in communication with encryption processor 260. Compression engine 238 compresses network packets bi-directionally between clients 102 and servers 106 and/or between one or more appliances 200.

Packet engine 240 may manage kernel-level processing of packets received and transmitted by appliance 200 via network stacks 267 to send and receive network packets via network ports 266. Packet engine 240 may operate in conjunction with encryption engine 234, cache manager 232, policy engine 236 and compression engine 238, for example to perform encryption/decryption, traffic management such as request-level content switching and request-level cache redirection, and compression and decompression of data.

User space 202 is a memory area or portion of the operating system used by user mode applications or programs otherwise running in user mode. A user mode application may not access kernel space 204 directly and uses service calls in order to access kernel services. User space 202 may include graphical user interface (GUI) 210, a command line interface (CLI) 212, shell services 214, health monitor 216, and daemon services 218. GUI 210 and CLI 212 enable a system administrator or other user to interact with and control the operation of appliance 200, such as via the operating system of appliance 200. Shell services 214 include the programs, services, tasks, processes or executable instructions to support interaction with appliance 200 by a user via the GUI 210 and/or CLI 212.

Health monitor 216 monitors, checks, reports and ensures that network systems are functioning properly and that users are receiving requested content over a network, for example by monitoring activity of appliance 200. In some embodiments, health monitor 216 intercepts and inspects any network traffic passed via appliance 200. For example, health monitor 216 may interface with one or more of encryption engine 234, cache manager 232, policy engine 236, compression engine 238, packet engine 240, daemon services 218, and shell services 214 to determine a state, status, operating condition, or health of any portion of the appliance 200. Further, health monitor 216 may determine if a program, process, service or task is active and currently running, check status, error or history logs provided by any program, process, service or task to determine any condition, status or error with any portion of appliance 200. Additionally, health monitor 216 may measure and monitor the performance of any application, program, process, service, task or thread executing on appliance 200.

Daemon services 218 are programs that run continuously or in the background and handle periodic service requests received by appliance 200. In some embodiments, a daemon service may forward the requests to other programs or processes, such as another daemon service 218 as appropriate.

As described herein, appliance 200 may relieve servers 106 of much of the processing load caused by repeatedly opening and closing transport layer connections to clients 102 by opening one or more transport layer connections with each server 106 and maintaining these connections to allow repeated data accesses by clients via the Internet (e.g., “connection pooling”). To perform connection pooling, appliance 200 may translate or multiplex communications by modifying sequence numbers and acknowledgment numbers at the transport layer protocol level (e.g., “connection multiplexing”). Appliance 200 may also provide switching or load balancing for communications between the client 102 and server 106.

As described herein, each client 102 may include client agent 120 for establishing and exchanging communications with appliance 200 and/or server 106 via a network 104. Client 102 may have installed and/or execute one or more applications that are in communication with network 104. Client agent 120 may intercept network communications from a network stack used by the one or more applications. For example, client agent 120 may intercept a network communication at any point in a network stack and redirect the network communication to a destination desired, managed or controlled by client agent 120, for example to intercept and redirect a transport layer connection to an IP address and port controlled or managed by client agent 120. Thus, client agent 120 may transparently intercept any protocol layer below the transport layer, such as the network layer, and any protocol layer above the transport layer, such as the session, presentation or application layers. Client agent 120 can interface with the transport layer to secure, optimize, accelerate, route or load-balance any communications provided via any protocol carried by the transport layer.

In some embodiments, client agent 120 is implemented as an Independent Computing Architecture (ICA) client developed by Citrix Systems, Inc. of Fort Lauderdale, FL. Client agent 120 may perform acceleration, streaming, monitoring, and/or other operations. For example, client agent 120 may accelerate streaming an application from a server 106 to a client 102. Client agent 120 may also perform end-point detection/scanning and collect end-point information about client 102 for appliance 200 and/or server 106. Appliance 200 and/or server 106 may use the collected information to determine and provide access, authentication and authorization control of the client's connection to network 104. For example, client agent 120 may identify and determine one or more client-side attributes, such as: the operating system and/or a version of an operating system, a service pack of the operating system, a running service, a running process, a file, presence or versions of various applications of the client, such as antivirus, firewall, security, and/or other software.

### C. Systems and Methods for Providing Virtualized Application Delivery Controller

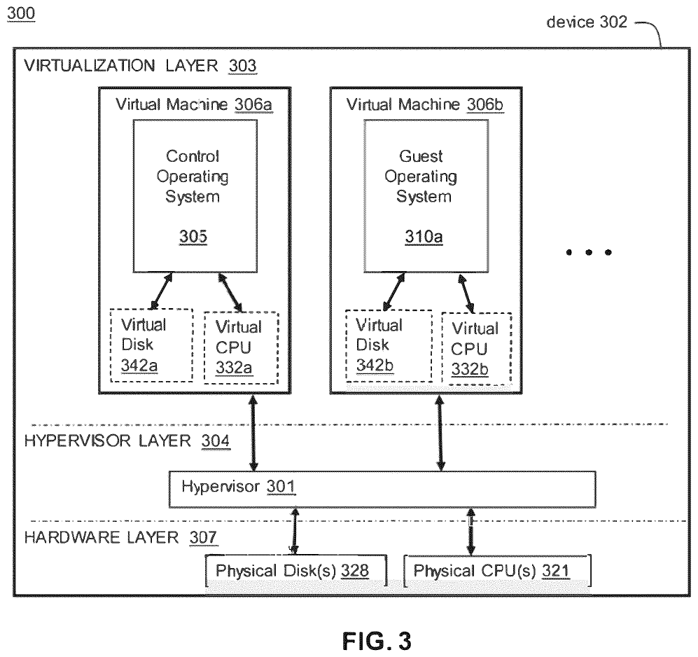

Referring now to FIG. 3, a block diagram of a virtualized environment 300 is shown. As shown, a computing device 302 in virtualized environment 300 includes a virtualization layer 303, a hypervisor layer 304, and a hardware layer 307. Hypervisor layer 304 includes one or more hypervisors (or virtualization managers) 301 that allocates and manages access to a number of physical resources in hardware layer 307 (e.g., physical processor(s) 321 and physical disk(s) 328) by at least one virtual machine (VM) (e.g., one of VMs 306) executing in virtualization layer 303. Each VM 306 may include allocated virtual resources such as virtual processors 332 and/or virtual disks 342, as well as virtual resources such as virtual memory and virtual network interfaces. In some embodiments, at least one of VMs 306 may include a control operating system (e.g., 305) in communication with hypervisor 301 and used to execute applications for managing and configuring other VMs (e.g., guest operating systems 310) on device 302.

In general, hypervisor(s) 301 may provide virtual resources to an operating system of VMs 306 in any manner that simulates the operating system having access to a physical device. Thus, hypervisor(s) 301 may be used to emulate virtual hardware, partition physical hardware, virtualize physical hardware, and execute virtual machines that provide access to computing environments. In an illustrative embodiment, hypervisor(s) 301 may be implemented as a Citrix Hypervisor by Citrix Systems, Inc. of Fort Lauderdale, FL. In an illustrative embodiment, device 302 executing a hypervisor that creates a virtual machine platform on which guest operating systems may execute is referred to as a host server. 302

Hypervisor 301 may create one or more VMs 306 in which an operating system (e.g., control operating system 305 and/or guest operating system 310) executes. For example, the hypervisor 301 loads a virtual machine image to create VMs 306 to execute an operating system. Hypervisor 301 may present VMs 306 with an abstraction of hardware layer 307, and/or may control how physical capabilities of hardware layer 307 are presented to VMs 306. For example, hypervisor(s) 301 may manage a pool of resources distributed across multiple physical computing devices.

In some embodiments, one of VMs 306 (e.g., the VM executing control operating system 305) may manage and configure other of VMs 306, for example by managing the execution and/or termination of a VM and/or managing allocation of virtual resources to a VM. In various embodiments, VMs may communicate with hypervisor(s) 301 and/or other VMs via, for example, one or more Application Programming Interfaces (APIs), shared memory, and/or other techniques.

In general, VMs 306 may provide a user of device 302 with access to resources within virtualized computing environment 300, for example, one or more programs, applications, documents, files, desktop and/or computing environments, or other resources. In some embodiments, VMs 306 may be implemented as fully virtualized VMs that are not aware that they are virtual machines (e.g., a Hardware Virtual Machine or HVM). In other embodiments, the VM may be aware that it is a virtual machine, and/or the VM may be implemented as a paravirtualized (PV) VM.

Although shown in FIG. 3 as including a single virtualized device 302, virtualized environment 300 may include a plurality of networked devices in a system in which at least one physical host executes a virtual machine. A device on which a VM executes may be referred to as a physical host and/or a host machine. For example, appliance 200 may be additionally or alternatively implemented in a virtualized environment 300 on any computing device, such as a client 102, server 106 or appliance 200. Virtual appliances may provide functionality for availability, performance, health monitoring, caching and compression, connection multiplexing and pooling and/or security processing (e.g., firewall, VPN, encryption/decryption, etc.), similarly as described in regard to appliance 200.

In some embodiments, a server may execute multiple virtual machines 306, for example on various cores of a multi-core processing system and/or various processors of a multiple processor device. For example, although generally shown herein as “processors” (e.g., in FIGS. 1C, 2 and 3), one or more of the processors may be implemented as either single- or multi-core processors to provide a multi-threaded, parallel architecture and/or multi-core architecture. Each processor and/or core may have or use memory that is allocated or assigned for private or local use that is only accessible by that processor/core, and/or may have or use memory that is public or shared and accessible by multiple processors/cores. Such architectures may allow work, task, load or network traffic distribution across one or more processors and/or one or more cores (e.g., by functional parallelism, data parallelism, flow-based data parallelism, etc.).

Further, instead of (or in addition to) the functionality of the cores being implemented in the form of a physical processor/core, such functionality may be implemented in a virtualized environment (e.g., 300) on a client 102, server 106 or appliance 200, such that the functionality may be implemented across multiple devices, such as a cluster of computing devices, a server farm or network of computing devices, etc. The various processors/cores may interface or communicate with each other using a variety of interface techniques, such as core to core messaging, shared memory, kernel APIs, etc.

In embodiments employing multiple processors and/or multiple processor cores, described embodiments may distribute data packets among cores or processors, for example to balance the flows across the cores. For example, packet distribution may be based upon determinations of functions performed by each core, source and destination addresses, and/or whether: a load on the associated core is above a predetermined threshold; the load on the associated core is below a predetermined threshold; the load on the associated core is less than the load on the other cores; or any other metric that can be used to determine where to forward data packets based in part on the amount of load on a processor.

For example, data packets may be distributed among cores or processes using receive-side scaling (RSS) in order to process packets using multiple processors/cores in a network. RSS generally allows packet processing to be balanced across multiple processors/cores while maintaining in-order delivery of the packets. In some embodiments, RSS may use a hashing scheme to determine a core or processor for processing a packet.

The RSS may generate hashes from any type and form of input, such as a sequence of values. This sequence of values can include any portion of the network packet, such as any header, field or payload of network packet, and include any tuples of information associated with a network packet or data flow, such as addresses and ports. The hash result or any portion thereof may be used to identify a processor, core, engine, etc., for distributing a network packet, for example via a hash table, indirection table, or other mapping technique.

### D. Systems and Methods for Providing a Distributed Cluster Architecture

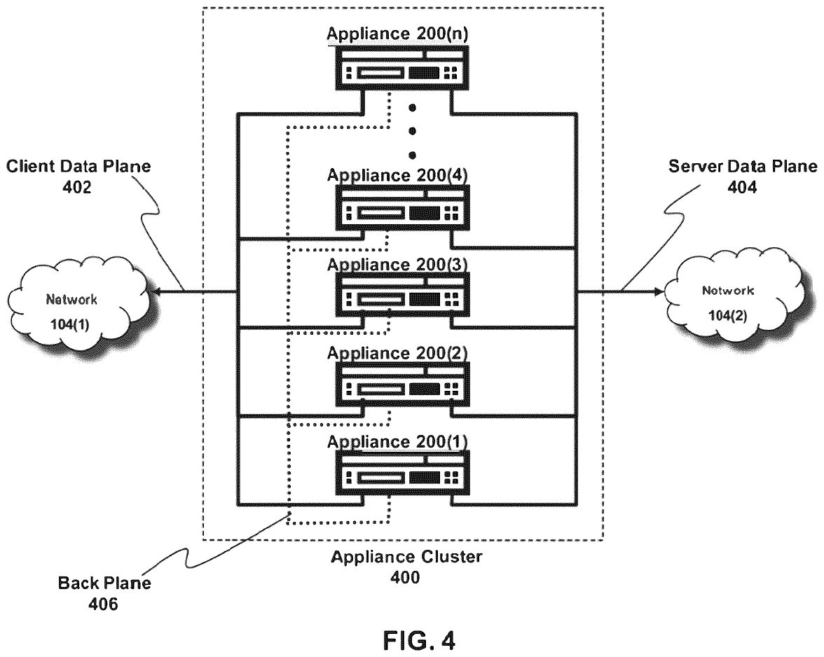

Although shown in FIGS. 1A and 1B as being single appliances, appliances 200 may be implemented as one or more distributed or clustered appliances. Individual computing devices or appliances may be referred to as nodes of the cluster. A centralized management system may perform load balancing, distribution, configuration, or other tasks to allow the nodes to operate in conjunction as a single computing system. Such a cluster may be viewed as a single virtual appliance or computing device. FIG. 4 shows a block diagram of an illustrative computing device cluster or appliance cluster 400. A plurality of appliances 200 or other computing devices (e.g., nodes) may be joined into a single cluster 400. Cluster 400 may operate as an application server, network storage server, backup service, or any other type of computing device to perform many of the functions of appliances 200 and/or 205.

In some embodiments, each appliance 200 of cluster 400 may be implemented as a multi-processor and/or multi-core appliance, as described herein. Such embodiments may employ a two-tier distribution system, with one appliance if the cluster distributing packets to nodes of the cluster, and each node distributing packets for processing to processors/cores of the node. In many embodiments, one or more of appliances 200 of cluster 400 may be physically grouped or geographically proximate to one another, such as a group of blade servers or rack mount devices in a given chassis, rack, and/or data center. In some embodiments, one or more of appliances 200 of cluster 400 may be geographically distributed, with appliances 200 not physically or geographically co-located. In such embodiments, geographically remote appliances may be joined by a dedicated network connection and/or VPN. In geographically distributed embodiments, load balancing may also account for communications latency between geographically remote appliances.

In some embodiments, cluster 400 may be considered a virtual appliance, grouped via common configuration, management, and purpose, rather than as a physical group. For example, an appliance cluster may comprise a plurality of virtual machines or processes executed by one or more servers.

As shown in FIG. 4, appliance cluster 400 may be coupled to a first network 104(1) via client data plane 402, for example to transfer data between clients 102 and appliance cluster 400. Client data plane 402 may be implemented a switch, hub, router, or other similar network device internal or external to cluster 400 to distribute traffic across the nodes of cluster 400. For example, traffic distribution may be performed based on equal-cost multi-path (ECMP) routing with next hops configured with appliances or nodes of the cluster, open-shortest path first (OSPF), stateless hash-based traffic distribution, link aggregation (LAG) protocols, or any other type and form of flow distribution, load balancing, and routing.

Appliance cluster 400 may be coupled to a second network 104(2) via server data plane 404. Similarly to client data plane 402, server data plane 404 may be implemented as a switch, hub, router, or other network device that may be internal or external to cluster 400. In some embodiments, client data plane 402 and server data plane 404 may be merged or combined into a single device.

In some embodiments, each appliance 200 of cluster 400 may be connected via an internal communication network or back plane 406. Back plane 406 may enable inter-node or inter-appliance control and configuration messages, for inter-node forwarding of traffic, and/or for communicating configuration and control traffic from an administrator or user to cluster 400. In some embodiments, back plane 406 may be a physical network, a VPN or tunnel, or a combination thereof.

### E. Systems and Methods for Establishing Rendezvous Connections in a Cloud Service Including One or More Multi-Core Nodes

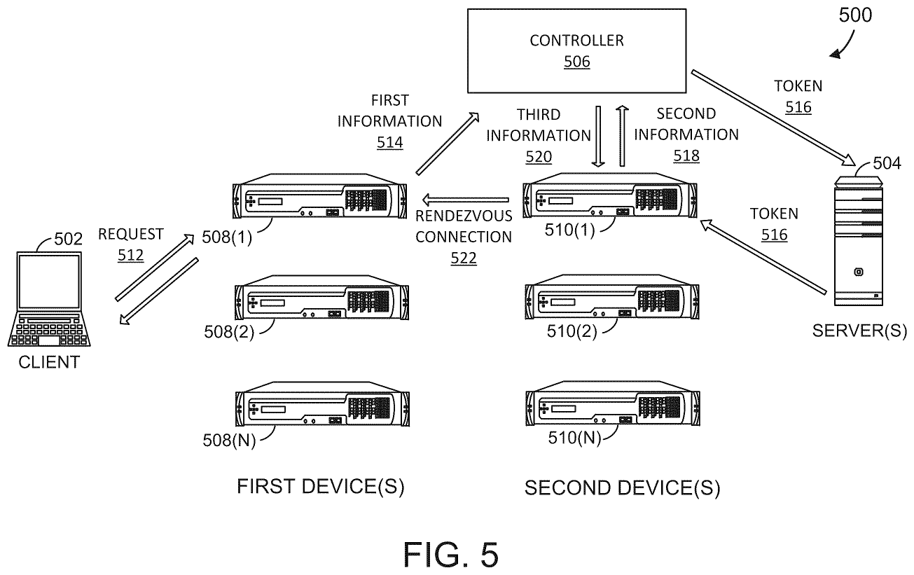

FIG. 5 is a block diagram of a system 500 for establishing rendezvous connections in a cloud service environment, according to an example implementation of the present disclosure. The system 500 may include one or more clients (or client devices) 502, one or more servers 504, and a controller 506 communicably coupled to various intermediary devices (e.g., one or more first devices 508(1)-508(N) (referred to generally as “first device 508”) and one or more second devices 510(1)-510(N) (referred to generally as “second device 510”)). As described in greater detail below, a client 502 may be configured to communicate, transmit, send, or otherwise provide a request 512 to a first device 508, to establish a connection with a server 504 hosting a resource or service. The first device 508 may be configured to transmit first information 514 to the controller 506, where the first information 514 includes connection information corresponding to the request 512 and configuration data of the first device 508. The controller 506 may be configured to generate and transmit a token 516 to the server 504 (e.g., to a connector of the server 504) according to the first information 514. The server 504 may correspondingly transmit the token 516 to a second device 510, to establish an outbound connection with the client 502. The second device 510 may be configured to transmit second information 518 (including the token 516) to the controller 506. The controller 506 may be configured to respond with third information 520, which causes the second device 510 to establish a rendezvous connection 522 with the first device 508.

The components, elements, hardware, and/or devices of FIG. 5 may be similar to the components, elements, hardware, and/or devices described above with reference to FIGS. 1-4. For example, in some cases, the client(s) 502, server(s) 504, and intermediary devices may be respective examples of the client 102, server 106, and appliance 200, as described herein with reference to FIGS. 1-4. The client(s) 502, server(s) 504, controller 506, and intermediary devices may be communicably coupled to each other via one or more networks (e.g., local area network, wide area network, etc.), and communicate via one or more protocols.

The controller 506 may be any computing device configured to interactive with and/or otherwise manage communication between the intermediary devices (e.g., the first devices 508 and second devices 510) within the system 500. The controller 506 may be any computing device including processor(s) and non-transitory machine-readable storage medium. The storage medium may be configured to store instructions executable by the processor(s) for executing or otherwise performing various functions described in greater detail below.

The intermediary devices may include first devices 508 and second devices 510. In various embodiments, the first devices 508 may be or include service nodes, and the second devices 510 may be or include flow redirectors. Services nodes may be designed or configured to manage and process requests from clients 502, by interfacing with various services and/or servers 504. The service nodes may be configured to perform various network functions such as packet routing, maintaining network sessions, performing load balancing, traffic optimization at the network and/or service level, etc. Flow redirectors may be designed or configured to manage flow of packets between nodes within the network. For example, the flow redirectors may be configured to control traffic flow and routing between various service nodes and servers 504. The service nodes and flow redirectors may be implemented on or deployed via various hardware and/or virtualized hardware appliances, such as those appliances described above with reference to FIGS. 1-4. In various embodiments, the service nodes and/or flow redirectors may include multi-core service nodes and/or multi-core flow redirectors. For example, a service node may be or include a multi-core service node, where the service node is implemented on a device or hardware (including virtualized device or hardware) including multiple cores, where two or more cores handle data packet processing and routing. Similarly, a flow redirector may be or include a multi-core flow redirector, where the flow redirector is implemented on a device or hardware (including virtualized device or hardware) including multiple cores, where two or more cores handle data packet processing and routing.

As shown in FIG. 5, a client 502 may be configured to generate and transmit, communicate, send, or otherwise provide a request 512 to a first device 508 (e.g., a service node). The request 512 may be or include a request to establish a connection with a server 504 hosting, provisioning, or otherwise providing a resource or service to be accessed by the client 502. The request 512 may include information (e.g., connection information) for the connection which is to be established. For example, the connection information may include source and destination addresses, port numbers, protocol types, and session identifiers, such as tokens or cookies, which uniquely identify the client-server session. In some embodiments and implementations, the connection information may further include security-related data, such as encryption keys or authentication credentials (e.g., of the user of the client device 502 and/or associated with the client device 502), metadata, such as time-stamps, client application details, and/or priority indicators. The client 502 may be configured to generate and transmit the request to the service node 508, responsive to detecting a user action, such as an input selection (e.g., at the client 502) to access a resource/application/service hosted by the server 504. Additionally or alternatively, the client 502 may be configured to automatically generate and transmit the request 512 based on predetermined events or conditions, such as a periodic update check, background synchronization, and/or expiration of an existing session.

In some embodiments, the client 502 may be configured to determine which of the plurality of service nodes 508 in which to send the request 512. For example, the client device 502 may be configured to select a service node 508 from the plurality of service nodes 508, based on one or more factors, such as the geographic proximity of the service node 508 to the client 502 (e.g., to reduce latency and improve the speed of the connection). In some embodiments, the client device 502 may be configured to select the service node 508 based on real-time network conditions, such as the current load or availability of each service node 508 (e.g., by querying the network and/or receive periodic updates, relating congestion of the service nodes 508). The client 502 may be configured to transmit the request 512 to the selected service node 508.

As shown in FIG. 5, the client 502 may be configured to transmit the request 512 to a first device 508(1) of the plurality of first devices 508(1)-(N). It should be understood that, while the term first device 508 is used interchangeably with the term service node, in various embodiments, the first devices 508 may be or include respective services nodes. Additionally or alternatively, the first devices 508 may be or include respective cores of a single service node. As such, the first devices 508 referred to herein may be or include service nodes and/or cores of a service node.

The service node 508 may be configured to receive the request from the client 502. Responsive to receiving the request, the service node 508 may be configured to perform various processing steps relating to the request to manage communication between the client 502 and the server 504. In some embodiments, the service node 508 may be configured to receive the request on a particular core of the service node 508. The service node 508 may be configured to determine the particular core of the service node 508 which is to receive and process the request, according to various factors of the service node 508. For example, the service node 508 may be configured to select or otherwise determine the core based on, according to, and/or using hashing algorithm or a predefined set of rules to distribute incoming requests across available cores (e.g., evenly or substantially evenly across the cores).

In some embodiments, the service node 508 may be configured to select the core which is to manage the request and corresponding connections, using a hashing algorithm. For example, the service node 508 may be configured to select the core by computing a hash using a hash key (e.g., an RSS hash using an RSS hash key). The service node 508 may be configured to compute the hash over a two or four tuple (e.g., using the source IP address and port, destination IP address and port). The service node 508 may be configured to use a layout file or other layout information of the service node, to generate or configure a central processing unit (CPU) indirection table. The service node 508 may be configured to share, transmit, communicate, or otherwise provide the hash key and CPU indirection table with hardware of the service node 508 (e.g., a network interface card (NIC) or dedicated core of the service node 508). As the hash key is updated at the service node 508 (e.g., responsive to a reboot or other periodic update), the service node 508 may be configured to update the CPU indirection table, and share the updated hash key and CPU indirection table with the hardware of the service node (e.g., the NIC and/or dedicated core of the service node 508). When a packet is received, the service node 508 (e.g., the hardware of the service node, such as the NIC/dedicated core) may be configured to compute the hash value using the hash key and information of the connection (e.g., source and destination IP addresses and ports), and use the hash value to access the CPU indirection table to determine the core of the service node 508 which is to manage the packet.

The service node 508 may be configured to generate first information 514 based on the request 512 and the service node 508. The first information 514 may include the connection information described above (e.g., information relating to the connection between the client 502 and server 504 which is to be established) and configuration data of the service node 508. The configuration data may be or include information/data/identifiers which are associated with or used to identify the particular core which is managing the request and connection.

In some embodiments, the first information 514 may include a hash key, layout information of the service node 508, and an identifier of the core which is managing the request/connection. The hash key may be or include a key which is used for determining/generating/configuring a hash or hash value. In some embodiments, the hash key may be generated by the service node 508 at reboot and be fixed until a subsequent reboot. In some embodiments, the hash key may be periodically updated (e.g., between reboots). The hash key may be the same as the hash key referenced above for generating the CPU indirection table. The service node 508 may be configured to use the hash key to compute/generate a hash (e.g., an RSS hash) based on a combination of certain connection information and core details of the service node. For example, the service node 508 may be configured to use the hash key to generate the hash based on parameters from the request (e.g., a combination of two or four tuples of the source IP address [of the client 502], destination IP address [of the server 504], source port and destination port, extension headers in instances of IPv6 communication protocol, etc.). The service node 508 may be configured to generate the configuration information to include layout information of the service node 508. The layout information may be or include core details relating to the core(s) of the service node 508 which are managing traffic/data packets for various connections. For example, the layout information may include a number of cores of the service node 508, core identifiers for each of the cores, central processing unit (CPU) identifiers, weightage associated with each core, etc. The service node 508 may be configured to generate the configuration information to include an identifier of the core of the service node 508 which is managing the request. For example, the service node 508 may be configured to incorporate a core identifier of the core which received the request (or is otherwise managing the request) into the configuration information.

The service node 508 may be configured to communicate, transmit, send, or otherwise provide the first information 514 to the controller 506. The service node 508 may be configured to provide the first information 514 to the controller 506, to establish the connection between the client 502 and server 504. The controller 506 may be designed or configured to generate a token 516 based on or according to the first information 514. In some embodiments, the controller 506 may be configured to generate the token 516 by encoding or incorporating portions of the first information 514 or data corresponding to the first information 514, such as session identifiers, cryptographic elements, or processing instructions, into a packet, key, credential, or other token. In some embodiments, the controller 506 may be may configured to apply various encryption algorithms, hashing functions, or other token generation algorithms to generate the token 516 unique to the connection (e.g., which is established or to be established between the client 502 and server 504).

The controller 506 may be configured to transmit, communicate, send, or otherwise provide the token 516 to the server 504. In some embodiments, the controller 506 may be configured to provide the token 516 to a connector of the server 504. For example, the server 504 may include a connector which manages inbound and outbound requests for the server 504. The controller 506 may be configured to transmit the token 516 to the server 504, which is received by the connector of the server 504. The server 504 may be configured to use the token 516 to establish a corresponding (e.g., outbound) connection from the server 504 to the client 502. In some embodiments, the controller 506 may be configured to communicate, send, or otherwise provide additional information to the server 504 (e.g., the connector of the server 504) with the token 516. For example, the additional information may include information relating to a particular flow redirector 510, a particular core of the flow redirector 510, configuration information of the flow redirector 510 which is to receive the token 516 from the server 504, and so forth.

In some embodiments, the token 516 may be used by the devices for controlling communication on the connection between the client 502 and server 504. For example, where a packet, signal, request, or other communication is sent by one device or node to another device or node, such communication may include the token 516. As described in greater detail below, a receiving device of such a communication may use the token 516 and other information to route traffic to the correct core of an intermediary device (e.g., of the service node 508, flow redirector 510, etc.), to avoid packet steering within the intermediary device.

To establish the corresponding (e.g., outbound) connection, the connector (e.g., of the server 504) may be configured to transmit, send, or otherwise provide the token 516 to a flow redirector 510. In some embodiments, the server 504 may be configured to select the flow redirector 510 in which to transmit the token 516, in a manner similar to the client 502 selecting the service node 508. In some embodiments, the server 504 may be configured to select the flow redirector 510 in which to transmit the token 516, according to the information sent by the controller 506 to the server 504 with the token 516 (e.g., where such information indicates which flow redirector 510 in which to transmit the token 516). The connector may be configured to transmit the token 516 to the flow redirector 510, to establish an outbound connection which can be used for the connection between the client 502 and server 504. Like the service node 508, a particular core of the flow redirector 510 may be configured to receive and/or otherwise manage the packet from the server 504 including the token 516.

The flow redirector 510 may be configured to generate second information 518 to transmit to the controller 506, to establish the rendezvous connection 522 with the service node 508 (e.g., with the correct core of the service node 508). The second information 518 may include the token 516 (or data corresponding to the token 516). The flow redirector 510 may be configured to transmit the token 516 (or data corresponding thereto) to the controller 506, to facilitate identification of the corresponding session/request/service node/core associated with the request from which the token 516 was generated. The controller 506 may be configured to use the second information 518 to generate/determine/identify third information 520 for communicating to the flow redirector 510, to facilitate the flow redirector 510 establishing the rendezvous connection 522 with the service node 508. The content(s) of the third information 520 may depend on the content(s) of the second information 518.

In some embodiments, the second information 518 may include configuration data of the flow redirector 510 (which may be similar to the configuration data of the service node 508 included in the first information 514). The configuration data of the flow redirector 510 may include, e.g., a hash key for the flow redirector 510, layout information, and/or core identifier. The controller 506 may be configured to use the configuration data of the flow redirector 510 and the configuration data of the service node 508, to generate the third information 520. In various embodiments, the third information 520 may include source and destination IP addresses, source and destination ports, etc. for the rendezvous connection 522.

In some embodiments, the controller 506 may be configured to determine the source and destination IP addresses and ports using the first and second information 514, 518 The controller 506 may be configured to determine/identify the first information 514 using the token 516. For example, the controller 506 may be configured to use the token 516 to identify the first information 514 (e.g., the controller 506 may use the token 516 to access a data store or memory location where the first information 514 is stored, or the token 516 may be structured in such a way that it encodes the first information 514). The controller 506 may be configured to identify, from/using/based on the first information 514, the core identifier for the core of the service node 508 which is managing the connection between the client 502 and server 504. Likewise, the controller 506 may be configured to use the second information to identify the core identifier of the core of the flow redirector 510 which is managing the connection between the client 502 and the server 504. The controller 506 may be configured to determine the source and destination IP addresses and ports based on the combination of cores which are managing the connection on the service node 508 and flow redirector 510. In this regard, the controller 506 may be configured to use the configuration data of the service node 508 and the configuration data of the flow redirector 510, to set or otherwise determine the source and destination IP addresses and ports, such that the rendezvous connection 522 is established between the proper core of the service node 508 and the proper core of the flow redirector 510.

In some embodiments, the controller 506 may be configured to determine possible destination IP address and port combinations for the rendezvous connection using the first information, which the controller 506 may identify using the token. In some embodiments, the second configuration data may be configured to identify the core of flow redirector 510 that received the token. Using second information, the controller 506 may be configured to determine IP address and port combinations which can be used as source IP and Port for rendezvous connection. Using first and second configuration data (i.e. RssKey, Layout Information and Core details associated with first and second configuration data), the controller 506 may be configured to determine the combination of source IP, source Port, Destination IP and Destination Port for the rendezvous connection, such that steering is avoided on both service node 508 and flow rerdirector 510.

In some embodiments, the second information 518 may not include the configuration data of the flow redirector 510. Instead, the second information 518 may include the token 516, and any other information which can be included in the second information 518 (e.g., absent the configuration data of the flow redirector 510). In various embodiments, the controller 506 may be configured to identify the first information 514 using the token 516 (e.g., in a manner as described above). However, because the controller 506 may not have access to the configuration data for the flow redirector 510, the controller 506 may provide (e.g., as the third information 520) the first information 514 or data corresponding to the first information 514 to the flow redirector 510. In such embodiments, the flow redirector 510 may be configured to use the third information 520 to determine the source and destination IP addresses and ports for the rendezvous connection (e.g., in a manner similar to the determination of such information made by the controller 506 as described above).

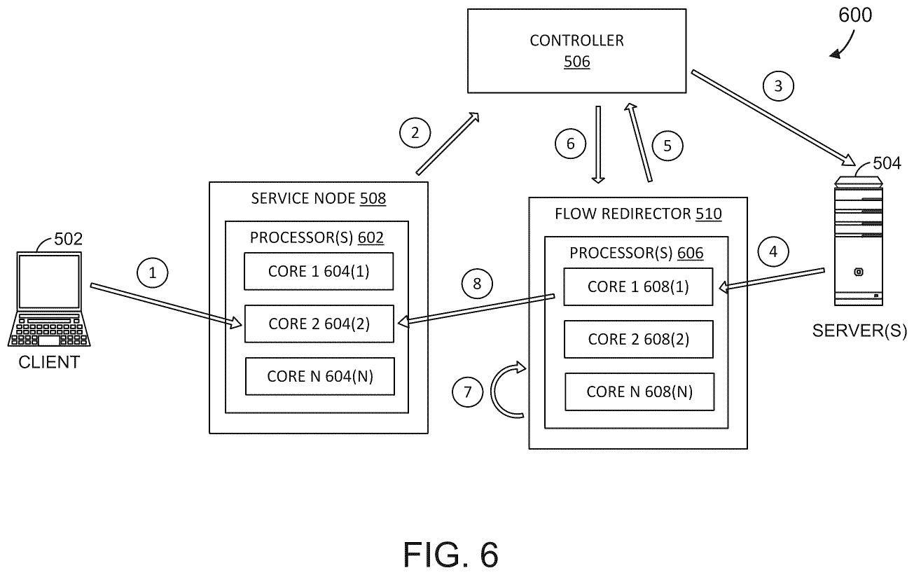

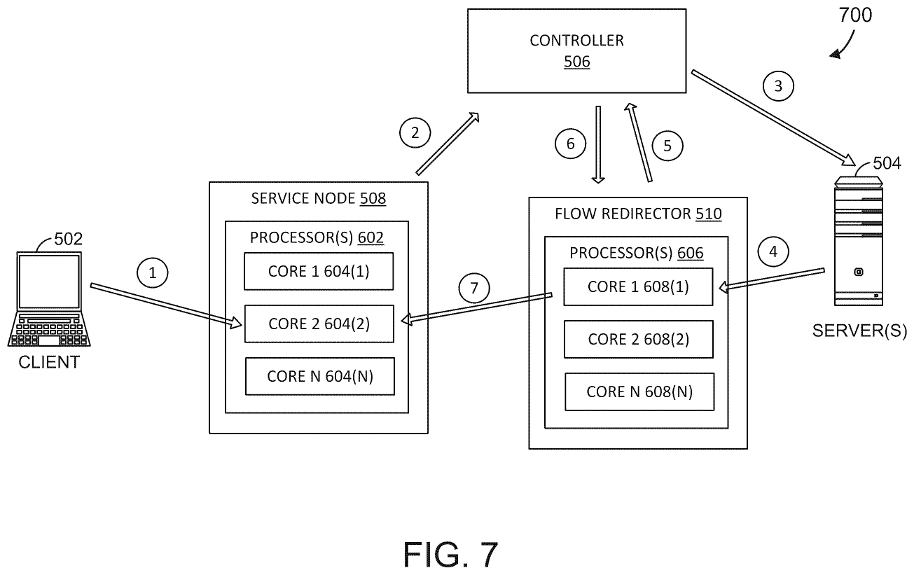

Referring now to FIG. 6 and FIG. 7, depicted are system flows 600, 700 of establishing rendezvous connections in a cloud service environment, according to example implementations of the present disclosure. As shown in FIG. 6 and FIG. 7, the service node 508 (and similarly, the flow redirector 510) may include respective processor(s) 602, 606. The processors 602, 606 may be or include multi-core processors (e.g., the processor(s) 602 of the service node 610 may include cores 604(1)-604(N), and the processor(s) 606 of the flow redirector 512 may include cores 608(1)-608(N)).

At process 1, the client 502 may transmit a request (e.g., request 512) to a service node 508, to establish a connection between the client 502 and a server 504. The request 512 may be received or otherwise managed by a particular core 604 of the service node 508. In the example shown in FIG. 6 and FIG. 7, the request 512 may be managed by the second core 604(2) of the service node 510. For example, the service node 508 may compute the hash value and, using the hash value and CPU indirection table, determine that the second core 604(2) is to manage the request (e.g., to cause the request 512 to be received and/or managed by the second core 604(2)).

At process 2, the service node 508 may transmit information (e.g., first information 514) to the controller 506. The information may be, e.g., connection information relating to the request received at process 1, and configuration data relating to the service node 508. The configuration data may include information which can be used to select/configure/determine an address and port of the service node 508, for a rendezvous connection with the core of the service node 508 which is managing the request 512 and/or connection (e.g., the second core 604(2) of the service node 508). For example, the configuration data may include a hash key of the service node 510, layout information relating to cores of the service node 508, and an identifier of the core of the service node 508 which is managing the request/connection (e.g., an identifier of the second core 604(2)).

At process 3, the controller 506 may generate and transmit a token 516 to the server(s) 504. The controller 506 may generate the token 516 based on or according to the first information received at process 2. For example, the controller 506 may generate the token 516 to uniquely identify or otherwise be uniquely associated with the first information. The controller 506 may transmit the token 516 to a connector of the server(s) 504.

At process 4, the server(s) 504 (e.g., the connector of the server(s) 504) may transmit the token 516 to the flow redirector 510. The server(s) 504 may transmit the token 516 to the flow redirector 510, to establish an outbound connection relating to the connection between the client 502 and the server 504. The token 516 may be received or otherwise managed by a particular core 608 of the flow redirector 508. In the example shown in FIG. 6 and FIG. 7, the token 516 may be managed by the first core 608(1) of the flow redirector 510. For example, like the service node 508, the flow redirector 510 may execute use a hash key and layout information of the flow redirector 510 to determine/generate a CPU indirection table for the flow redirector 510, and generate a hash value using the hash key and connection information to determine that the first core 608(1) is to manage packets corresponding to the connection (e.g., to thereby cause the token 516 to be received and/or managed by the first core 608(1)).

At process 5, the flow redirector 510 may transmit information (e.g., second information 518) to the controller 506. In the embodiment shown in FIG. 6, the information may include, at least, the token 516. In the embodiment shown in FIG. 7, the information may include, at least, the token 516 and configuration data of the flow redirector 510 (which may be similar to the configuration data of the service node 508 included in the first information at process 2).

At process 6, the controller 506 may transmit information (e.g., third information 520) to the flow redirector 510, to facilitate the flow redirector 510 in establishing a connection (e.g., the rendezvous connection 522) between the proper core of the service node 508 and the proper core of the flow redirector 510. The information transmitted by the controller 506 to the flow redirector 510 may depend on the type/contents of information sent to the controller 506 at process 5.

Where, at process 5, the information includes the token 516, the controller 506 may identify the first information (e.g., received at process 2) using the token 516. The controller 506 may transmit the first information (or data corresponding to the first information) to the flow redirector 510 at process 6. In this example, and as shown in FIG. 6, the system flow 600 may include an extra process (e.g., process 7) in which the flow redirector 510 determines or identifies the source and destination IP addresses and ports for the rendezvous connection 522 using the information from the controller 506. For example, the flow redirector 510 may use its own configuration data and the configuration data of the service node 508, to identify the source and destination IP addresses and ports.

Where, at process 5, the information includes the token 516 and the configuration data of the flow redirector 510, the controller 506 may identify the first information (e.g., received at process 2) using the token 516 as described above. The controller 506 may identify source and destination IP addresses and ports for the rendezvous connection, using the configuration data from the first information and the configuration data of the flow redirector. In other words, the controller 506 may identify or determine the source and destination IP addresses and ports for the rendezvous connection, using the configuration data of the service node and the configuration data of the flow redirector, such that the rendezvous connection is between the proper cores of the service node and flow redirector. The controller 506 may identify the source and destination IP addresses and ports in a manner similar to the embodiments described above with reference to FIG. 5. In such embodiments, the information sent at process 6 of FIG. 7 may include the source and destination IP addresses and ports. In this regard, the controller 506 may determine the source and destination IP addresses and ports on behalf of the flow redirector 510, such that the flow redirector 510 may not need the extra process to do so as illustrated in the difference between FIG. 6 and FIG. 7.

At process 8 of FIG. 6 and process 7 of FIG. 7, the flow redirector 510 may initiate establishment of the rendezvous connection between the flow redirector 510 and the service node 508. The flow redirector 510 may initiate establishment of the rendezvous connection 522, by transmitting data/signal/other packet to request establishment of the rendezvous connection 522. The packet may be addressed according to the source and destination IP addresses and ports as described above. In this regard, the packet may be managed from the core of the flow redirector 510 which received the token 516 (e.g., the first core 608(1) of the flow redirector 510) to the core of the service node 508 which received or otherwise is to manage the connection (e.g., the second core 604(2) of the service node 508). Once the rendezvous connection is established, traffic exchanged via the rendezvous connection, may be managed by the first core 608(1) and the second core 604(2). For example, traffic received by the service node 508 for transmission to the server 504 via the flow redirector 510, may be handled/addressed from the second core 604(2) of the service node 508 to the first core 608(1) of the flow redirector 510. Likewise, traffic received by the flow redirector 510 for transmission to the client 502 via the service node 508, may be handled/addressed from the first core 608(1) of the flow redirector 510 to the second core 604(2) of the service node 508. Such implementations may avoid traffic steering between cores of both the service node 508 and the flow redirector 510.

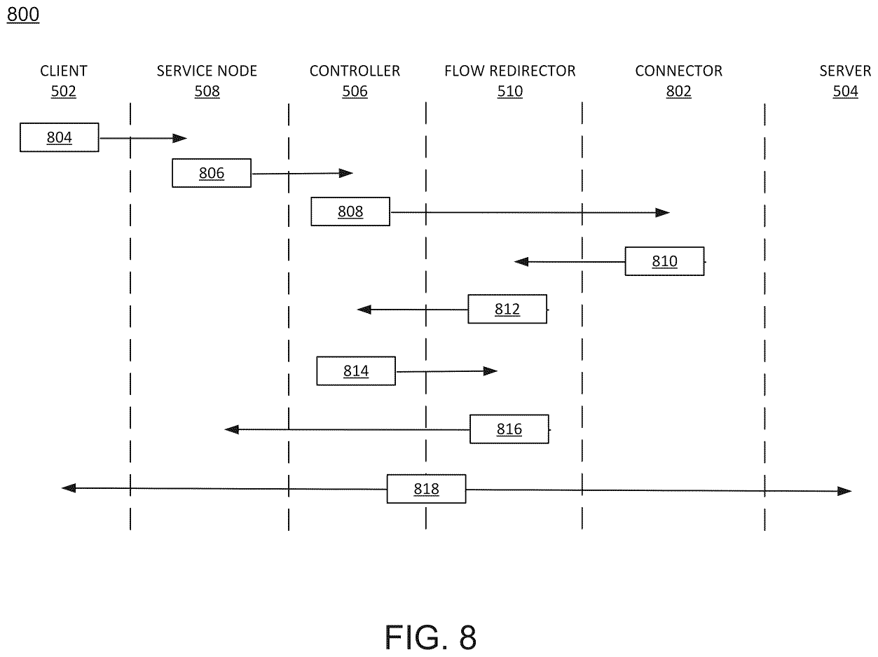

Referring now to FIG. 8, depicted is a process flow 800 for establishing rendezvous connections corresponding to a connection in a cloud service environment, according to an example implementation of the present disclosure. As shown in FIG. 8, the process flow 800 may be implemented across the hardware, elements, components, etc. described above (e.g., the client 502, server 504 and (connector 802 of the server 504), the controller 506, service node(s) 508, and flow redirector 510.

At step 804, the client 502 may transmit a request to the service node 508, where the request includes connection information for establishing a connection between the client 502 and the server. The client 502 may transmit the request responsive to detecting a user action, periodically or responsive to a predetermined event (e.g., a reset/expiry of a current session, etc.). At step 806, the service node 508 may transmit first information (e.g., connection information and configuration data of the service node 508) to the controller 506. The service node may transmit the first information, to indicate which core of the service node 508 is to handle/manage the connection between the client 502 and server 504. At step 808, the controller 506 may generate and transmit a token 516 to the connector 802. The controller 506 may generate the token based on or according to the first information received at step 806. The controller 506 may generate the token so that, at subsequent instances in which the controller 506 receives the token, the controller 506 can determine the first information which corresponds to the token.

At step 810, the connector 802 may transmit the token to the flow redirector 510. The connector 802 may transmit the token 516 to the flow redirector 510, to establish an outbound connection from the server 504 to the client 502. At step 812, the flow redirector 510 may transmit second information (e.g., the token and, in some implementations, other information) to the controller 506. The flow redirector 510 may transmit the second information, to establish the rendezvous connection between the proper cores of the service node 508 and flow redirector 510. At step 814, the controller 506 may transmit third information, in response to the second information, for establishing the rendezvous connection. The third information may depend at least partially based on the content of the second information. For example, the third information may include configuration data of the service node 508, where the second information includes the token 516 (e.g., absent configuration data of the flow redirector 510). As another example, the third information may include source and destination IP addresses and ports, where the second information includes the token 516 and configuration data of the flow redirector 510.

At step 816, the flow redirector 510 may transmit, send, or otherwise provide a signal (or other packet, transmission, communication, etc.) to the service node 508, to establish the rendezvous connection between the core of the service node 508 and the core of the flow redirector 510. The flow redirector 510 may provide the signal addressed with source and destination IP addresses and ports, such that the signal lands/is managed by the core of the service node 508 which received/is managing the connection and the connection is established between that core of the service node 508 and the core of the flow redirector 510 which received the token 516 from the connector 804 of the server. At step 818, the client 502 and server 504 may communicate using the connections (e.g., the outbound connection inclusive of the rendezvous connection) between the client 502 and server 504.

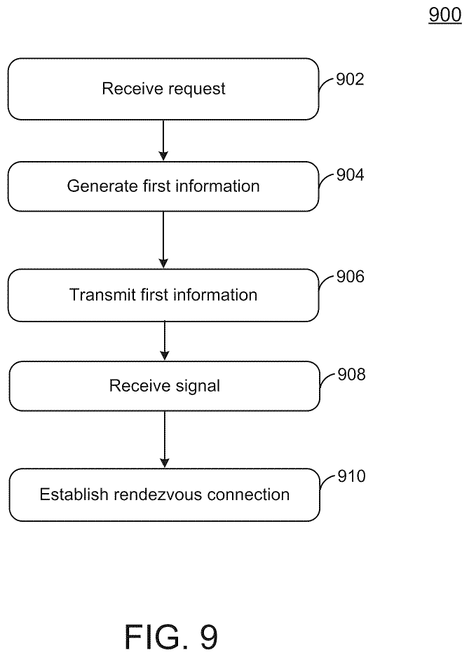

Referring now to FIG. 9-FIG. 11, depicted are flowcharts showing example methods 900, 1000, 1100 of establishing rendezvous connections in cloud service environments, according to example implementations of the present disclosure. The methods 900, 1000, 1100 may be executed or performed by the components, elements, or hardware described above with reference to FIG. 1-FIG. 8. In some embodiments, the method 900 may be executed or performed by the service node 508, the method 1000 may be executed or performed by the controller 506, and the method 1100 may be executed or performed by the flow redirector.

Beginning with FIG. 9, at step 902, a service node may receive a request. In some embodiments, the service node may receive the request from a client. The service node may receive the request to establish a connection between the client and a server. The service node may receive the request responsive to a user action at the client (e.g., to launch an application or resource of the server), periodically, responsive to a predetermined event (e.g., refresh or expiration of a session with the server), and so forth. In some embodiments, the service node may receive the request at a particular core of the service node. For example, the service node may initially receive the request at a front-end of the service node (e.g., an NIC and/or a dedicated core of the service node), determine a hash value using a hash key and connection information (e.g., source and destination IP addresses and ports), and use the hash value and a CPU indirection table to determine the core of the service node in which to provide the request for receipt and processing thereby.

At step 904, the service node may generate first information. In some embodiments, the service node may generate the first information based on the request, the service node, and the core which received and is managing the request/connection. The service node may generate the first information to include connection information (e.g., which may be included / incorporated into the request), and configuration data of the service node. The connection information may be or include information which relates to the connection which is to be established between the client and server (e.g., authentication/verification information, security information, access rights, etc.). The configuration data may include a hash key, layout information of the service node, and an identifier of the core of the service node which is transmitting the request.

At step 906, the service node may transmit first information. In some embodiments, the service node may transmit the first information generated at step 904, to a controller. The service node may transmit the first information, to indicate to the controller which core of the service node is managing the connection.

At step 908, the service node may receive a signal. In some embodiments, the service node may receive the signal at the core of the service node which is managing the request received at step 902. In this regard, the signal may be addressed such that the signal lands on/is managed by the core of the service node which is managing the request. The service node may receive the signal from a flow redirector. The service node may receive the signal from the flow redirector, in connection with the flow redirector attempting to establish a rendezvous connection from the flow redirector to the service node. At step 910, the service node and flow redirector may establish a rendezvous connection.

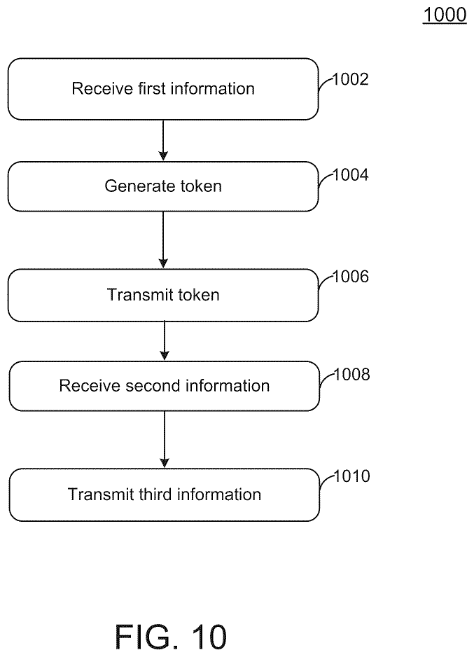

Turning now to FIG. 10, at step 1002, the controller may receive first information. In some embodiments, the controller may receive the first information from the service node. The controller may receive the first information, responsive to step 906 of FIG. 9. At step 1004, the controller may generate a token. The controller may generate the token for identifying the first information. The controller may generate the token based on or according to the first information. In some embodiments, the controller may store the first information in memory or other data storage, in association with an identifier corresponding to the token. In some embodiments, the controller may generate the token by encoding or otherwise configuring the token using the first information (e.g., the token is representative of the first information).

At step 1006, the controller may transmit the token. In some embodiments, the controller may transmit the token to a connector of the server. The controller may transmit the token, to cause the connector to establish an outbound connection (e.g., including a rendezvous connection). At step 1008, the controller may receive second information. The controller may receive the second information from a flow redirector. The controller may receive the second information, responsive to the flow redirector receiving the token from the connector (e.g., as part of the connector establishing the outbound connection). In some embodiments, the second information may include the token. In some embodiments, the second information may include the token and configuration data of the flow redirector.

At step 1010, the controller may transmit third information. In some embodiments, the controller may transmit the third information to the flow redirector. The controller may transmit the third information, to cause the flow redirector to establish the rendezvous connection with the proper core of the service node. In some embodiments, the controller may determine/identify the third information, based on the contents of the second information. For example, where the second information includes the token (e.g., absent configuration data of the flow redirector), the controller may identify the third information as the configuration data of the service node (e.g., hash key, the layout and core identifier) or information corresponding to the configuration data. Where the second information includes the token and the configuration data of the flow redirector, the controller may identify the third information as the source and destination IP addresses and ports. The controller may identify the source and destination IP addresses and ports based on the configuration data of the service node and the flow redirector. The source and destination IP addresses may be determined, to cause the rendezvous connection to be established between the proper core of the service node and the proper core of the flow redirector.

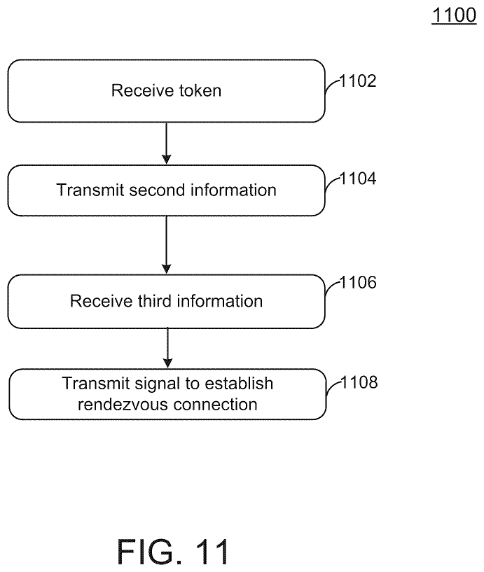

Turning now to FIG. 11, at step 1102, a flow redirector may receive a token. The flow redirector may receive the token from the connector of the server. The flow redirector may receive the token, as part of the connector establishing the outbound connection (e.g., responsive to step 1006 of FIG. 10). In some embodiments, a core of the flow redirector my receive the token. The core of the flow redirector may receive the token, responsive to a front-end of the flow redirector (e.g., a NIC and/or a dedicated core of the flow redirector) receiving the token from the connector, determining a hash value using a hash key and connection information (e.g., source and destination IP addresses and ports), and determining the core in which to provide the token for receipt and processing thereby based on the hash value and CPU indirection table for the flow redirector.

At step 1104, the flow redirector may transmit second information. In some embodiments, the flow redirector may transmit the second information to the controller (e.g., which may be received at step 1008 of FIG. 10). The flow redirector may transmit the second information, to request corresponding information for establishing the rendezvous connection between the flow redirector and the service node. The flow redirector may generate the second information to include the token (or data corresponding to the token). In some embodiments, the flow redirector may generate the second information to include configuration data corresponding to the flow redirector. The configuration data may indicate the core of the flow redirector which received the token (e.g., at step 1102) from the connector of the server. For example, the configuration data may include the layout information of the flow redirector, the identifier of the core which received the token, and a hash key for the flow redirector.

At step 1106, the flow redirector may receive third information. In some embodiments, the flow redirector may receive the third information from the controller. The flow redirector may receive the third information from the controller, responsive to step 1010 of FIG. 10. The third information may include data which facilitates establishing the rendezvous connection between the flow redirector and the service node. The third information may include source and destination IP addresses and ports (e.g., for the flow redirector and the service node, respectively). The third information may include configuration data of the service node, associated with the token. Where the third information includes the configuration data of the service node, the flow redirector may determine the source and destination IP addresses and ports using the configuration data of the service node and corresponding configuration data of the flow redirector. At step 1108, the flow redirector may transmit a signal to establish the rendezvous connection. In some embodiments, the flow redirector may transmit the signal to the destination IP address and port of the service node, from the source IP address and port of the flow redirector. The flow redirector may transmit the signal, to establish the rendezvous connection between the proper cores of the service node and flow redirector.

### F. Example Embodiments for Establishing Rendezvous Connections in a Cloud Service

The following examples pertain to further example embodiments, from which permutations and configurations will be apparent.
Example 1 may include a method. The method may include receiving, by a controller, from a first device intermediary to a client and a server, first information relating to a request to establish a connection from a client to the server received by the first device, the first information including connection information corresponding to the request and configuration data of the first device. The method may include transmitting, by the controller to a connector of the server, a token generated by the controller according to the first information from the first device. The method may include receiving, by the controller, from a second device intermediary to the client and the server, second information relating to establishing a rendezvous connection corresponding to the connection, the second information including the token received by the second device from the connector of the server. The method may include transmitting, by the controller, to the second device, third information, to cause the second device to establish the rendezvous connection with the first device.
Example 2 includes the subject matter of example 1, where the first device comprises a service node of one or more service nodes, the service node including a plurality of cores, and wherein the configuration information identifies a core of the plurality of cores which received the request from the client device.
Example 3 includes the subject matter of any of examples 1 or 2, where the second device comprises a flow redirector including a plurality of cores.
Example 4 includes the subject matter of any of examples 1 to 3, where the controller receives the second information, responsive to the flow redirector receiving the token from server at a core of the plurality of cores of the flow redirector, and where the rendezvous connection is established between the core of the flow redirector which received the token from the server, and a core of the first device which received the request.
Example 5 includes the subject matter of any of examples 1 to 4, where the configuration data comprises a hash key for the first device, layout information of the first device, and an identifier of a core of the first device which received the first request.
Example 6 includes the subject matter of any of examples 1 to 5, where the configuration data comprises first configuration data of the first device, the second information further comprises second configuration data of the second device, and where the third information comprises a source address, a source port, a destination address and a destination port to be used for the rendezvous connection between the first device and the second device.
Example 7 includes the subject matter of any of examples 1 to 6, where the third information comprises the configuration data of the first device, causing the second device to determine a source address, a source port, a destination address and a destination port to be used for the rendezvous connection between the first device and the second device based on the configuration data of the first device and configuration data of the second device.
Example 8 includes the subject matter of any of examples 1 to 7, where the method further includes generating, by the controller, the token corresponding to the first information received from the first device.
Example 9 includes the subject matter of any of examples 1 to 8, where the first device comprises a core of a service node, the second device comprises a core of a flow redirector, and where the rendezvous connection is established between the core of the service node which received the request, and the core of the flow redirector which received the token.
Example 10 includes a system. The system may include one or more first devices. At least one of the one or more first devices may include a processor comprising a plurality of cores. A core of the plurality of cores may be configured to receive, from a client device, a request to establish a connection between the client and a server. The core may be configured to transmit, to a controller, first information relating to the request, the first information including connection information corresponding to the request and configuration data of the first device, the controller transmitting a token corresponding to the first information to a connector of the server. The core may be configured to establish, responsive to receiving a signal from a second device, a rendezvous connection between the core of the first device and the second device, the second device transmitting the signal to the first device according to second information received from the controller, the second information determined by the controller based on the token received by the second device from the connector of the server.
Example 11 may include the subject matter of example 10, where the one or more first devices comprise one or more service nodes, and wherein the second device comprises a flow redirector.
Example 12 includes a controller including one or more processors configured to receive, from a first device intermediary to a client and a server, first information relating to a request to establish a connection from a client to the server received by the first device, the first information including connection information corresponding to the request and configuration data of the first device. The one or more processors may be configured to transmit, to a connector of the server, a token generated by the controller according to the first information from the first device. The one or more processors may be configured to receive, from a second device intermediary to the client and the server, second information relating to establishing a rendezvous connection corresponding to the connection, the second information including the token received by the second device from the connector of the server. The one or more processors may be configured to transmit, to the second device, third information, to cause the second device to establish the rendezvous connection with the first device.
Example 13 includes the subject matter of example 12, where the first device comprises a service node of one or more service nodes, the service node including a plurality of cores, and where the configuration information identifies a core of the plurality of cores which received the request from the client device.
Example 14 includes the subject matter of any of examples 12 or 13, where the second device comprises a flow redirector including a plurality of cores.
Example 15 includes the subject matter of any of examples 12 to 14, where the one or more processors receive the second information, responsive to the flow redirector receiving the token from server at a core of the plurality of cores of the flow redirector, and where the rendezvous connection is established between the core of the flow redirector which received the token from the server, and a core of the first device which received the request.
Example 16 includes the subject matter of any of examples 12 to 15, where the configuration data comprises a hash key for the first device, layout information of the first device, and an identifier of a core of the first device which received the first request.
Example 17 includes the subject matter of any of examples 12 to 16, where the configuration data comprises first configuration data of the first device, the second information further comprises second configuration data of the second device, and wherein the third information comprises a source address, a source port, a destination address and a destination port to be used for the rendezvous connection between the first device and the second device.
Example 18 includes the subject matter of any of examples 12 to 17, where the third information comprises the configuration data of the first device, causing the second device to determine a source address, a source port, a destination address and a destination port to be used for the rendezvous connection between the first device and the second device based on the configuration data of the first device and configuration data of the second device.
Example 19 includes the subject matter of any of examples 12 to 18, where the one or more processors are further configured to generate the token corresponding to the first information received from the first device.
Example 20 includes the subject matter of any of examples 12 to 19, where the first device comprises a core of a service node, the second device comprises a core of a flow redirector, and where the rendezvous connection is established between the core of the service node which received the request, and the core of the flow redirector which received the token.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It should be understood that the systems described above may provide multiple ones of any or each of those components and these components may be provided on either a standalone machine or, in some embodiments, on multiple machines in a distributed system. The systems and methods described above may be implemented as a method, apparatus, or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents. References to “or” can be construed as inclusive so that any terms described using “or” can indicate any of a single, more than one, and all of the described terms. For example, a reference to “at least one of ‘A’ and ‘B’” can include only “A,” only “B,” as well as both “A” and “B.” Such references used in conjunction with “comprising” or other open terminology can include additional items.

It will be further understood that various changes in the details, materials, and arrangements of the parts that have been described and illustrated herein may be made by those skilled in the art without departing from the scope of the following claims.

What is claimed is:

1. A method comprising:
receiving, by a controller, from a first device intermediary to a client and a server, first information relating to a request to establish a connection from the client to the server received by the first device, the first information including connection information corresponding to the request and configuration data of the first device;
transmitting, by the controller to a connector of the server, a token generated by the controller according to the first information from the first device;
receiving, by the controller, from a second device intermediary to the client and the server, second information relating to establishing a rendezvous connection corresponding to the connection, the second information including the token received by the second device from the connector of the server; and
transmitting, by the controller, to the second device, third information, to cause the second device to establish the rendezvous connection with the first device.

2. The method of claim 1, wherein the first device comprises a service node of one or more service nodes, the service node including a plurality of cores, and wherein the configuration data identifies a core of the plurality of cores which received the request from the client.

3. The method of claim 1, wherein the second device comprises a flow redirector including a plurality of cores.

4. The method of claim 3, wherein the controller receives the second information, responsive to the flow redirector receiving the token from the server at a core of the plurality of cores of the flow redirector, and wherein the rendezvous connection is established between the core of the flow redirector which received the token from the server, and a core of the first device which received the request.

5. The method of claim 1, wherein the configuration data comprises a hash key for the first device, layout information of the first device, and an identifier of a core of the first device which received the request.

6. The method of claim 1, wherein the configuration data comprises first configuration data of the first device, the second information further comprises second configuration data of the second device, and wherein the third information comprises a source address, a source port, a destination address and a destination port to be used for the rendezvous connection between the first device and the second device.

7. The method of claim 1, wherein the third information comprises the configuration data of the first device, causing the second device to determine a source address, a source port, a destination address and a destination port to be used for the rendezvous connection between the first device and the second device based on the configuration data of the first device and configuration data of the second device.

8. The method of claim 1, further comprising generating, by the controller, the token corresponding to the first information received from the first device.

9. The method of claim 1, wherein the first device comprises a core of a service node, the second device comprises a core of a flow redirector, and wherein the rendezvous connection is established between the core of the service node which received the request, and the core of the flow redirector which received the token.

10. A system, comprising:
one or more first devices, at least one of the one or more first devices comprising:
a processor comprising a plurality of cores, wherein a core of the plurality of cores is configured to:
receive, from a client, a request to establish a connection between the client and a server;
transmit, to a controller, first information relating to the request, the first information including connection information corresponding to the request and configuration data of the first device, the controller transmitting a token corresponding to the first information to a connector of the server; and
establishing, responsive to receiving a signal from a second device, a rendezvous connection between the core of the first device and the second device, the second device transmitting the signal to the first device according to second information received from the controller, the second information determined by the controller based on the token received by the second device from the connector of the server.

11. The system of claim 10, wherein the one or more first devices comprise one or more service nodes, and wherein the second device comprises a flow redirector.

12. A controller, comprising:
one or more processors configured to:
receive, from a first device intermediary to a client and a server, first information relating to a request to establish a connection from the client to the server received by the first device, the first information including connection information corresponding to the request and configuration data of the first device;
transmit, to a connector of the server, a token generated by the controller according to the first information from the first device;
receive, from a second device intermediary to the client and the server, second information relating to establishing a rendezvous connection corresponding to the connection, the second information including the token received by the second device from the connector of the server; and
transmit, to the second device, third information, to cause the second device to establish the rendezvous connection with the first device.

13. The controller of claim 12, wherein the first device comprises a service node of one or more service nodes, the service node including a plurality of cores, and wherein the configuration data identifies a core of the plurality of cores which received the request from the client.

14. The controller of claim 12, wherein the second device comprises a flow redirector including a plurality of cores.

15. The controller of claim 14, wherein the one or more processors receive the second information, responsive to the flow redirector receiving the token from the server at a core of the plurality of cores of the flow redirector, and wherein the rendezvous connection is established between the core of the flow redirector which received the token from the server, and a core of the first device which received the request.

16. The controller of claim 12, wherein the configuration data comprises a hash key for the first device, layout information of the first device, and an identifier of a core of the first device which received the request.

17. The controller of claim 12, wherein the configuration data comprises first configuration data of the first device, the second information further comprises second configuration data of the second device, and wherein the third information comprises a source address, a source port, a destination address and a destination port to be used for the rendezvous connection between the first device and the second device.

18. The controller of claim 12, wherein the third information comprises the configuration data of the first device, causing the second device to determine a source address, a source port, a destination address and a destination port to be used for the rendezvous connection between the first device and the second device, based on the configuration data of the first device and configuration data of the second device.

19. The controller of claim 12, wherein the one or more processors are further configured to generate the token corresponding to the first information received from the first device.

20. The controller of claim 12, wherein the first device comprises a core of a service node, the second device comprises a core of a flow redirector, and wherein the rendezvous connection is established between the core of the service node which received the request, and the core of the flow redirector which received the token.
